(19) United States
(12) Patent Application Publication
(10) Pub. No.: US 2021/0260885 A1
(43) Pub. Date: Aug. 26, 2021

(54) PRINT SUBSTANCE LEVEL MEASUREMENTS

(71) Applicant: Hewlett-Packard Development Company, L.P., Spring, TX (US)

(72) Inventors: Kenneth Williams, Vancouver, WA (US); Tobias Martin, Vancouver, WA (US)

(73) Assignee: Hewlett-Packard Development Company, L.P., Spring, TX (US)

(21) Appl. No.: 17/265,994

(22) PCT Filed: Nov. 14, 2018
(86) PCT No.: PCT/US2018/061046

§ 371 Date: Feb. 4, 2021

(51) Int. Cl. B41J 2/175; G01F 23/26; G01F 25/00

(52) U.S. Cl. CPC B41J 2/17566; B41J 2002/17579; G01F 25/0061; G01F 23/266

(57) ABSTRACT

Methods of determining a level of a print substance in a print substance reservoir are disclosed. A reference capacitance of a reference sensor is measured. The reference capacitance is representative of one of a full print substance reservoir and an empty print substance reservoir. A level capacitance of a level sensor is measured. A correlation between the reference sensor and the level sensor is applied to the measured reference capacitance to determine an adjusted reference capacitance. A fill level ratio is determined based on the measured level capacitance and the adjusted reference capacitance.

### BACKGROUND

Printing devices can include printers, copiers, fax machines, multifunction devices including additional scanning, copying, and finishing functions, all-in-one devices, or other devices such as pad printers to print images on three dimensional objects and three-dimensional printers (additive manufacturing devices). In general, printing devices apply a print substance often in a subtractive color space or black to a medium via a device component generally referred to as a print head. For example, printing devices that print in color mode may include supplies of subtractive color print substances such as cyan, yellow, magenta, and black or spot colors and printing devices that print in greyscale or monochromatic mode can include supplies of print substances such as black or a spot color. A medium can include various types of print media, such as plain paper, photo paper, polymeric substrates and can include any suitable object or materials to which a print substance from a printing device are applied including materials, such as powdered build materials, for forming three-dimensional articles. Print substances, such as printing agents, marking agents, and colorants, can include toner, liquid inks, or other suitable marking material that in some examples may be mixed with other print substances such as fusing agents, detailing agents, or other materials and can be applied to the medium. Printing devices can include a print substance container, which can include a refillable print substance container, to hold a print substance.

### BRIEF DESCRIPTION OF THE DRAWINGS

FIG. 1 is a block diagram illustrating an example method to determine a level of print substance in a print substance container.

FIG. 2 is a block diagram illustrating an example printing device to implement the example method of FIG. 1.

FIG. 3 is a schematic diagram illustrating an example print substance container, which can be included in the example printing device of FIG. 2.

FIG. 4 is a plan view schematic diagram illustrating an example system to implement the method of FIG. 1, and the example system can be included in the example printing device of FIG. 2.

### DETAILED DESCRIPTION

Printing devices with a continuous print substance supply system, such as continuous ink supply systems, include print substance containers having print substance reservoirs to store print substance for use with the print head. The print substance reservoirs are generally filled with print substance from a print substance supply at the discretion of the user. Users can determine an amount of print substance to provide to the print substance reservoir and a frequency to provide the print substance to the print substance reservoir. In general, the print substance reservoir includes an upper fill level to indicate when the print substance reservoir is full of print substance and a lower fill level to indicate when the print substance reservoir is sufficiently devoid of print substance, such as empty. Print substance can be provided to the print substance reservoir, such as when the print substance reservoir is sufficiently devoid of print substance, up to the upper fill level.

Printing devices employ level sensors to determine the level, such as height or amount, of the print substance in the print substance reservoir. Based on information obtained from the level sensor, printing devices can determine information such as how much print substance remains in the print substance reservoir and how much print substance has been added to the print substance reservoir when filled. Level sensors deployed in the print substance reservoir that contact the print substance can often accurately detect the amount of print substance, but the sensor structures can introduce sources of leaks, contamination, and corrosion into the print substance reservoir. Level sensors have been developed to continuously detect the amount of print substance from outside the print substance reservoir by measuring the capacitance of the interior of the print substance reservoir. Such sensors are affected by environmental changes such as temperature and humidity that degrade accuracy. For example, the dielectric materials of air and print substance proximate the level sensors may remain constant as the level of the print substance remains unchanged, but the dielectric properties of the air, print substance, or both may change due to temperature changes or other environmental effects, which results in changes to the measured capacitance that can lead to inaccurate determinations of the level of the print substance. Attempts to mitigate such environmental effects can result in sensor systems that are less accurate to changes in level of the print substance, which can affect the precision of the sensor.

This disclosure describes printing devices having print substance containers with sensor systems that do not contact the print substance to determine the level of print substance within a print substance reservoir. In one example, the sensor systems include a set of adjacent plate capacitor sensors that can continuously detect the level of the print substance within the print substance reservoir and can compensate for environmental affects that are often associated with sensors using adjacent plate capacitors. The sensor system includes a level sensor and a reference sensor such as a reference full sensor or a reference empty sensor. In one example, the sensor systems include a set of reference sensors comprising a reference full sensor and a reference empty sensor. The printing device includes a level measurement system operably coupled to a sensor system to detect the level of the print substance within the print substance reservoir and compensate for environmental affects such as temperature and humidity.

A printing device can include a print substance container, which can be installed or integrally formed in the printing device. In one example, the print substance container includes a print substance reservoir having a plurality of walls such as an upstanding wall and a base constructed from a dielectric material. The plurality of walls encloses an interior of the print substance reservoir, which can contain a print substance. As the print substance is consumed, such as via printing, an amount of print substance within the print substance reservoir decreases. Also, as print substance is added to the print substance reservoir, the amount of print substance within the print substance reservoir increases. The level of print substance, or a relative amount of print substance, within the interior of the print substance reservoir can be determined from a height of the print substance within the interior of the print substance reservoir. In one example, the level of the print substance can be determined with respect to the upstanding wall. For example, the upstanding wall includes a length, such as a length from the base, and the height of the print substance with respect to the upstanding wall varies along the length as the amount of the print substance within the interior of the print substance reservoir is added or consumed.

The print substance container includes a sensor system having a plurality of sensors that are configured to provide signals that can be processed to determine the level of the print substance within the interior of the print substance reservoir. Each of the sensors in the sensor system can include an adjacent plate capacitor, such as a coplanar capacitor. Adjacent plate capacitors are characterized by a pair of adjacent and elongated electrodes that may be formed as thin conductor strips or traces on a printed circuit assembly. The fringing electric fields of the adjacent electrodes in the adjacent plate capacitor penetrate into the dielectric material that is proximate to the adjacent plate capacitor. The variation of the dielectric properties of the proximate dielectric materials affects the inter-electrode capacitance, or capacitance, of the adjacent plate capacitor. Changes in the dielectric properties of surrounding dielectric materials can be detected by measuring the changes to capacitance of the adjacent plate capacitor. For the purposes of this disclosure, the adjacent plate capacitor of each sensor generates an effective fringing field, which is an amount of the fringing electric field of the adjacent capacitor that can measurably affect changes to capacitance of the sensor. Changes to the dielectric materials outside of the effective fringing field do not measurably affect the capacitance of the sensor.

The level sensor is attached to the upstanding wall such that the elongate electrodes of the adjacent plate capacitor extend along the length of the upstanding wall, and the capacitance of the level sensor is affected by the level the of print substance within the interior of the print substance reservoir. In one example, the length of the elongate electrodes of the level sensor on the upstanding wall extends from a selected minimum height of the print substance in the print substance reservoir, or lower fill level, to a selected maximum height of the print substance in the print substance reservoir, or upper fill level. The effective fringing field of the level sensor penetrates the upstanding wall and the interior of the print substance reservoir. As the print substance within the interior of the print substance reservoir is added or consumed, the dielectric properties of the interior of the print substance reservoir changes, and these changes affect the capacitance of the level sensor.

Environmental conditions can affect the dielectric properties of the air and print substance within the interior of the print substance reservoir, which can also affect the capacitance measurement of the adjacent plate capacitor in the level sensor. Such environment conditions can include temperature and humidity. In order to allow a printing device to account for changes in the level of the print substance and not to changes in capacitance due to environmental conditions, the sensor system can employ a reference sensor, which can include a reference full sensor or a reference empty sensor.

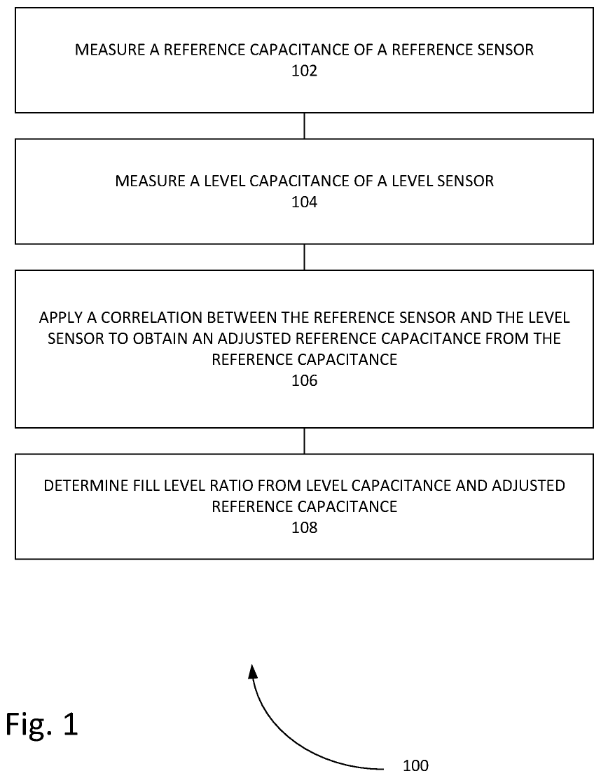

FIG. 1 illustrates an example method 100 of measuring a level of a print substance in a print substance reservoir using a capacitance sensor system having a level sensor and a reference sensor. The level sensor provides a level capacitance based on the height of the print substance in the print substance reservoir. The reference sensor is one of a reference full sensor to provide a reference capacitance a full print substance reservoir and a reference empty sensor to provide a reference capacitance of an empty print substance reservoir. A reference capacitance of one of a full print substance reservoir and an empty print substance reservoir is measured with the reference sensor at 102. A level capacitance is measured with the level sensor at 104. A correlation between the reference sensor and the level sensor is applied to the measured reference capacitance to determine an adjusted reference capacitance at 106. A fill level ratio is determined based on the measured level capacitance and the adjusted reference capacitance at 108, which can be used to determine an amount of print substance in the print substance reservoir. For example, the fill level ratio can be a percentage of the print substance reservoir that includes print substance or a percentage of the print substance reservoir that is devoid of print substance. In one example, the percentage of the print substance reservoir is determined for portion of the print substance reservoir between the upper fill level and the lower fill level. The level sensor is attached to the upstanding wall opposite the interior of the print reservoir and extending between the lower fill level and the upper fill level.

The capacitance sensor system can include a reference full sensor and a reference empty sensor. The reference full sensor is attached to the print substance reservoir proximate the base and opposite the interior of the print substance reservoir. For example, the reference full sensor can be attached to the print substance reservoir beneath the lower fill level. In one example, the reference full sensor can be attached to the print substance reservoir, such as to the base, so the effective fringing field of the reference full sensor is immersed in the print substance at the lower fill level. An amount of print substance is retained in the print substance reservoir proximate the base and opposite the reference full sensor such that the effective fringing field of the reference full sensor remains immersed in print substance at the lower fill level. The reference empty sensor is disposed on the print substance container such that the generated effective fringing field of the reference empty sensor does extend into the print substance within the interior of the print substance reservoir. In one example, the reference empty sensor is attached to a flange remote from the print substance reservoir or to the print substance reservoir above the upper fill level such that the generated effective fringing field of the reference empty sensor does not extend into the interior of the print substance reservoir. The measurement of the reference capacitance representative of one of a full print substance reservoir and an empty print substance reservoir of a reference capacitor with the reference sensor at 102 can include a measurement of a reference full capacitance representative of a full print substance reservoir with the reference full sensor to determine a reference full capacitance value and a measurement of a reference empty capacitance representative of an empty print substance reservoir with the reference empty sensor to determine a reference empty capacitance value.

In one example, a correlation is determined between the reference sensor and the level sensor. In the example of the reference full sensor and the reference empty sensor, correlations can be determined between the reference full sensor and the level sensor as well as between the reference empty sensor and the level sensor. A correlation between the reference sensor and the level sensor is provided because different specifications between the reference sensor and the level sensor, such as dimensions or areas of the electrodes, can result in different capacitance measurements of the same dielectric material. For example, a reference full sensor and a level sensor may provide different capacitance measurements for a print substance at the upper fill level. Likewise, a reference empty sensor and a level sensor may provide different capacitance measurements for a print substance at the lower fill level or a print substance reservoir devoid of print substance.

In one example method to determine a correlation, capacitances of the reference sensor can be measured with respect to a set of different, adjacent dielectric materials. Capacitances of the level sensor can also be measured with respect to the set of different, adjacent dielectric materials. In the example, the given dielectric material for the level sensor and the reference sensor can be measured under the same environmental conditions to provide the same dielectric properties.

The values of the measured capacitances of the reference sensor can be plotted against the corresponding values of the measured capacitance of the level sensor for each of the different, adjacent dielectric materials to determine the correlation. In a typical example, the correlation between the reference sensor and the level sensor for the dielectric materials can be efficiently approximated with a linear equation y=mx+b. The linear equation correlating the reference sensor to the level sensor can be provided as,

C_{Level}=mC_{Ref}+b.

in which C_{Ref} is the measured reference capacitance value, or the value of the capacitance of the reference sensor for a given dielectric material, C_{Level} is the measured level capacitance value, or the value of the capacitance of the level sensor for the given dielectric material, m is the determined slope of the linear equation of the correlation and b is the determined y-intercept of the linear equation of the correlation.

Each reference sensor can include different values for m and b for the linear equation of the correlation with the level sensor. For example, the correlation of a reference full sensor to the level sensor can be provided as

C_{Level}=m_{Full}C_{RefFull}+b_{Full}.

in which C_{RefFull} is the measured reference full capacitance value, or the value of the capacitance of the reference full sensor for a given dielectric material, C_{Level} is the measured level capacitance value, or the value of the capacitance of the level sensor for the given dielectric material, m_{Full} is the determined slope of the linear equation of the correlation between the reference full sensor and the level sensor, and b_{Full} is the determined y-intercept of the linear equation for the correlation of the reference full sensor to the level sensor. Similarly, the correlation of a reference empty sensor to the level sensor can be provided as

C_{Level}=m_{Empty}C_{RefEmpty}+b_{Empty}.

in which C_{RefEmpty} is the measured reference empty capacitance value, or the value of the capacitance of the reference empty sensor for a given dielectric material, C_{Level} is the measured level capacitance value, or the value of the capacitance of the level sensor for the given dielectric material, m_{Empty} is the determined slope of the linear equation of the correlation between the reference empty sensor and the level sensor, and b_{Empty} is the determined y-intercept of the linear equation for the correlation of the reference empty sensor to the level sensor.

The correlation between the reference sensor and the level sensor is applied to the measured reference capacitance to determine an adjusted reference capacitance at 106. In making a determination of adjusted reference capacitance, the linear equation with the determined and corresponding slope and y-intercept is applied to the measured reference capacitance. In an example in which a reference full capacitance value and a reference empty capacitance value have been measured, a correlation can be applied to both the reference full capacitance value and the reference empty capacitance value with the respective corresponding and determined slopes and y-intercepts.

Accordingly, the measured reference full capacitance value C_{RefFull} is applied to the respective corresponding and determined slope and y-intercept (m_{Full}, b_{Full}) in the linear equation as

C_{AdjFull}=m_{Full}C_{RefFull}+b_{Full}.

in which C_{AdjFull} is the adjusted reference full capacitance value, or the adjusted value of the capacitance of the reference full sensor, C_{RefFull} is the measured value of the capacitance of the reference full sensor, m_{Full} is the determined slope of the linear equation and b_{Full} is the determined y-intercept of the linear equation for the correlation of the reference full sensor to the level sensor.

Similarly, the measured reference empty capacitance value C_{RefFull} is applied to the respective corresponding and determined slope and y-intercept (m_{Empty}, b_{Empty}) in the linear equation as

C_{AdjEmpty}=m_{Empty}C_{RefEmpty}+b_{Empty}.

in which C_{AdjEmpty} is the adjusted reference empty capacitance, or the adjusted value of the capacitance of the reference empty sensor, C_{RefEmpty} is the measured value of the capacitance of the reference full sensor, or reference empty capacitance value, m_{Empty} is the determined slope of the linear equation of the determined correlation of the reference empty sensor and the level sensor, and b_{Empty} is the determined y-intercept of the linear equation for the correlation of the reference empty sensor to the level sensor.

In one example, the measured reverence capacitance is provided as a reference capacitance value, and the corresponding and determined slope m and y-intercept b can be provided from memory to determine the adjusted reference capacitance in a calculation such as with a processing device. In another example, the measured reference capacitance can be provided to a data structure such as a look up table to determine the adjusted reference capacitance.

The fill level ratio can be determined at 108 from a difference between the measured level capacitance and the adjusted reference capacitance. In one example, the ratio of the height of the print substance to the height between the upper and lower fill levels can be determined from,

Ratio_{Full}=(C_{Level}−C_{AdjEmpty})/(C_{AdjFull}−C_{AdjEmpty})

in which C_{Level} is the level capacitance value, or measured value of the capacitance of the level sensor, C_{AdjEmpty} is the adjusted reference empty capacitance, and C_{AdjFull} is the adjusted reference full capacitance. The percentage of the height between the upper and lower fill levels that is filled with print substance can be determined by 100*Ratio_{Full}. Additionally, the ratio of the height of the print substance consumed from the upper fill level to the height between the upper and lower fill levels can be determined from,

Ratio_{Empty}=(C_{AdjFull}−C_{Level})/(C_{AdjFull}−C_{AdjEmpty})

in which C_{Level} is the level capacitance value, or measured value of the capacitance of the level sensor, C_{AdjEmpty} is the adjusted reference empty capacitance, and C_{AdjFull} is the adjusted reference full capacitance. The percentage of the height between the upper and lower fill levels that is empty can be determined by 100*Ratio_{Empty}.

Either Ratio_{Full} or Ratio_{Empty} can be applied to the size and shape of the print substance reservoir to determine the amount of print substance in the print substance reservoir. For example, if the print substance reservoir is shaped like a rectangular box having a height H between the upper fill level and the lower fill level, a width W and a depth D, the amount of print substance in the print substance reservoir can be determined via H*W*D*Ratio_{Full}. Similarly, the amount of print substance consumed from the print substance reservoir can be determined via H*W*D*Ratio_{Empty}. In some example, one of the Ratio_{Full} and Ratio_{Empty} can provide a more accurate or precise measurement between the two ratios. For example, if the reference full sensor is more sensitive than the reference empty sensor, such as because of the dimensions of the electrodes or other physical characteristics, the Ratio_{Empty} determination, in which the C_{AdjFull} determination is more significant than the C_{AdjEmpty} determination, may be a more accurate or precise measurement of the relative amount of print substance in the print substance reservoir due to the effect of the reference full sensor on the C_{AdjFull} determination. Alternatively, if the reference empty sensor is more sensitive than the reference full sensor, such as because of the dimensions of the electrodes or other physical characteristics, the Ratio_{Full} determination, in which the C_{AdjEmpty} determination is more significant than the C_{AdjFull} determination, may be a more accurate or precise measurement of the relative amount of print substance in the print substance reservoir due to the effect of the reference empty sensor on the C_{AdjEmpty} determination.

Calculating the root sum square of the components of error can approximate the error in the measurement. The components of error can include values of the measured capacitances, slopes m and y-intercepts b. (Additionally, capacitors can include noise.) Values of the slope m that are larger than one will magnify the error of measured capacitance. In general, the larger the geometrical area of the sensor pads, the greater the sensitivity of the sensor. The area of the reference empty sensor can be enlarged easier than it is the reference full sensor because the reference empty sensor can be placed remote from the print substance reservoir, which leads to a lower value of slope for the reference full sensor m_{Full}, which can lead to smaller errors.

A correlation between the reference sensors can also be determined. A correlation between the reference full sensor and the reference empty sensor for a given print substance in a print substance reservoir can also be plotted on a graph and approximated with a linear equation. Capacitance measurements of the reference full sensor and the reference empty sensor can be compared to the correlation to determine whether the measurements fall on the linear equation. Measurements that fall on the linear equation can indicate the print substance within the print substance reservoir is within specification. Measurements that fall outside of an acceptable error of the correlation can indication the print substance within the reservoir is not within specification or that the print substance is not intended to be included in the print substance reservoir.

The example method 100 can be implemented to include hardware devices, programs, or hardware device and programs for controlling a system, such as a processing device having a processor and memory, to perform method 100 to determine a print substance level or an amount of print substance available or consumed within a print substance reservoir. For example, method 100 can be implemented as a set of executable instructions stored in a computer memory device for controlling the processor, and the values applied in the correlation at 106 can be stored in the memory. Additionally, the method 100 or aspects of the method can be implemented with an array or other data structure on a memory device that replaces runtime computations with an array indexing operation as a look up table.

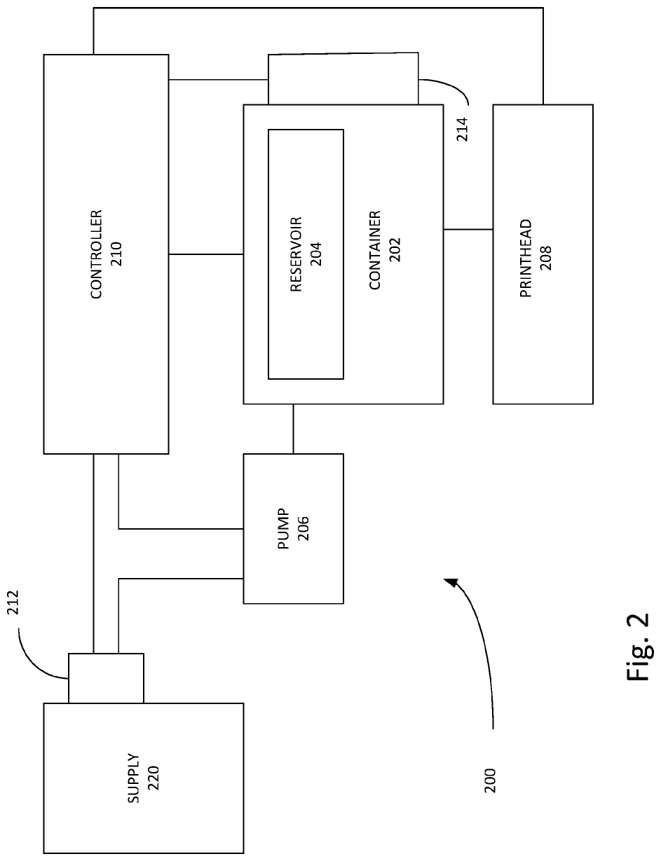

FIG. 2 illustrates an example printing device 200 that can implement example method 100 for measuring a level of a print substance. The printing device 200 can be constructed to stand in an operating configuration, and may include a set of feet or rollers (not shown) that can interface with a support structure, such as a floor or table, or ground. The printing device 200 includes a print substance container 202 having a print substance reservoir 204. In one example, a pump 206 can provide a consumable print substance to the print substance reservoir 204. Print substance in the print substance reservoir 204 is delivered to a print head 208 for printing or marking on a medium. Examples of a print head 208 can include ink jet print heads that apply an incompressible fluid, such as a liquid, as the print substance and print heads that apply particles of a toner as the print substance. Print substance reservoir 204 is in communication with channel 216 to receive print substance, and the print substance reservoir 204 is in communication with channel 218 to provide the print substance to the print head 208. The print substance container 202 includes sensor system 214, which can include a plurality of adjacent plate capacitors that can correspond with sensor system 114 and include a level sensor, a reference full sensor, and a reference empty sensor.

The pump 206, print head 208, and sensor system 214 are operably coupled to a controller 210. The controller 210 can include a combination of hardware and programming such as firmware stored on a memory device. The controller 210 can receive signals from the sensor system 214 to continuously determine a print substance level within the print substance reservoir 204 while the printing device is standing in the operating configuration. In one example, the sensor system 214 is operably coupled to a capacitance-to-digital converter that may be operably coupled to or included with the controller 210. The controller 210 can determine values associated with the signals provided from the sensor system 214 and resolve a level of the print substance in the print substance reservoir 204. From the determination of the level of the print substance, the controller 210 can further determine an amount of the print substance in the print substance reservoir 204. For example, the controller 210 can be configured to operate the pump 206 to provide providing print substance to the print substance reservoir 204 and to cease operation of the pump 206 once the upper fill level has been reached within the print substance reservoir 204 as determined by the sensor system 214. The controller 210 can also be configured to not provide print substance from the print substance reservoir 204 to the print head 208 once the lower fill level has been reached as determined by the sensor system 214. In another example, the channel 218 can be mechanically configured to stop extracting print substance from the print substance reservoir once the lower fill level has been reached within the print substance reservoir 204. Additionally, the controller 210 can be configured to select a sensitivity or precision of the capacitance measurement of the sensor system 214.

The printing device 200 can include one print substance container or multiple print substance containers. In some examples, the print substance container 202 can include multiple print substance reservoirs. In one example, the printing device 200 includes a print substance container 202 having a print substance reservoir, such as refillable print substance reservoir 204, for each color print substance of the printing device. The print substance container 202 provides the main storage of the print substance in the printing device 200. A printing device 200 in the subtractive color space can include a print substance reservoir to hold a cyan print substance, a print substance reservoir to hold a magenta print substance, a print substance reservoir to hold a yellow print substance, and a print substance reservoir to hold a black print substance. The printing device 200 may include other print substance reservoirs to hold other print substances such as photographic black, spot colors, or other colors used in the color space. In another example, the printing device 200 can implement a greyscale color space and the print substance reservoir 204 includes a black print substance. In one example, each print substance reservoir can be operably coupled to a corresponding pump, such as pump 206. Further, each print substance reservoir can be operably coupled to a print head, such as print head 208. In one example, each print substance reservoir can include a sensor system having a level sensor, a reference full sensor, and a reference empty sensor, or each print substance reservoir can include a level sensor and multiple print substance reservoirs can share a reference full sensor or a reference empty sensor.

The print substance reservoir 204 in one example is included with the printing device 200 and is distinguishable from a consumable cartridge that a user can readily remove and replace upon consumption of the print substance. In this example, the print substance reservoir 204 is a refillable reservoir. In the illustrated example, a supply vessel 220 is configured to be removably coupled to the printing device 200 to provide the print substance to the refillable print substance reservoir 204. The supply vessel 220 can include a supply output that is configured to be coupled to a print supply interface 212 of the printing device 200. In some examples, the print supply interface 212 can receives signals provided from a data structure located on the supply vessel 220 and can provide information regarding the print substance in the supply vessel 220 to the controller 210. The print supply interface 212 is operably coupled to the pump 206 to draw the print substance from the supply vessel 220 into the print substance reservoir 204 to store the print substance within the printing device 200 for use with the print head 208. In one example, the data structure may include information such as the amount of print substance remaining in the supply vessel 220 and type of print substance in the supply vessel 220. The controller 210 can receive the information and determine whether the print substance in the supply container 220 is compatible with a print substance intended to be included in the corresponding refillable reservoir 204. If the print substance in the supply container 220 is compatible with a print substance intended to be included in the corresponding refillable reservoir 204, the controller 210 can cause the pump 206 to draw print substance from the supply container 220 and provide the print substance to the print substance reservoir 204. In one example, the sensor system 214 and controller 210 can detect the amount of the print substance added to the print substance reservoir 204 and adjust the data regarding the amount of print substance remaining in the supply vessel on the data structure. The print substance may remain in the refillable reservoir 204 until the print substance is provided to the print head 208 for printing or marking on media.

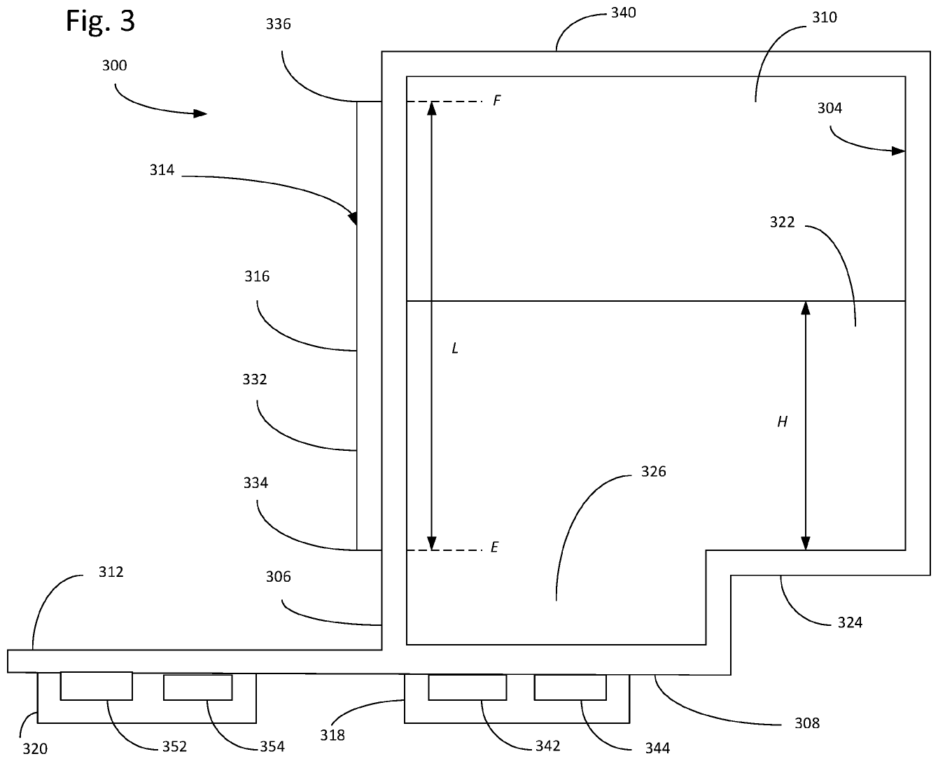

FIG. 3 illustrates an example schematic side view of print substance container 300 standing in the operating configuration for use with printing device 200. Print substance container 300 includes a print substance reservoir 302 having a plurality of walls 304 including an upstanding wall 306 and a base 308. The plurality of walls 304 may also include a reservoir cover 340. In the example, the upstanding wall 306 includes a length and is generally perpendicular to the base 308. The plurality of walls 304 can surround a reservoir interior 310. A print substance 322 can be included within the reservoir interior 310. While the printing device 200 is standing in an operating configuration, the print substance 322 includes a height H along the length of the upstanding wall, and, as the print substance is added and consumed, the height H of the print substance 322 along the upstanding wall 306 can vary between an upper fill level F and a lower fill level E.

The print substance container 300 can include a flange 312, which is a structure that is remote from the reservoir interior 310. In one example, the flange 312 is generally planar and extends from the print substance reservoir 302. In the example, the flange 312 is coplanar with the base 308. In one example, the upstanding wall 306, base 308, and flange 312 are formed of a same dielectric material. In one example, thicknesses of the upstanding wall 306, base 308, and flange 312 are substantially the same.

The print substance container 300 also includes a sensor system 314 to provide signals that can be processed to determine the level, or height H, of the print substance 322 within the reservoir interior 310. The sensor system 314 is configured to generally reduce the environmental effects that can skew a level determination based on a capacitance measured from just a level sensor.

The sensor system 314 includes a level sensor 316 attached to the upstanding wall 306 opposite the reservoir interior 310. The level sensor 316 includes an adjacent plate capacitor having a pair of elongate electrodes 332 of a length L. The electrodes 332 provide an effective fringing field into the reservoir interior 310, and the height H of the print substance 322 within the reservoir interior 310 affects the capacitance of the level sensor 316. The elongate electrodes 332 include a first end 334 proximate the base 308, and the first end 334 is at least as proximate the base 308 as a selected lower fill level E while the printing device 200 is standing in the operating configuration. The elongate electrodes 332 include a second end 336 distal from the base 308, and the second end 336 is at least as distal from the base 308 as a selected upper fill level F while the printing device 200 is standing in the operating configuration.

The sensor system 314 also includes a reference full sensor 318 attached to the print substance reservoir 302 proximate the base 308, such as attached to the base 308, opposite the reservoir interior 310. The reference full sensor 318 includes an adjacent plate capacitor having a first electrode 342 and a second electrode 344. The electrodes 342, 344 provide an effective fringing field into the reservoir interior 310, and the height H of the print substance 322 between the upper fill level F and the lower fill level E within the reservoir interior 310 does not measurably affect the capacitance of the reference full sensor 318. In one example, the lower fill level E is selected such that a sufficient amount of print substance 322 remains within the print substance reservoir 302 proximate the base 308 to cover the effective fringing field of the reference full sensor 318. The reference full sensor 318 can provide the controller 210 with a signal representative of the print substance reservoir 302 with print substance 322 filled to the upper fill level F subjected to environmental conditions.

In the example print substance reservoir 302, the plurality of walls 304 includes a bottom wall 324 that can intersect with the lower fill level E, be disposed between the lower fill level E and the base 308, or be coplanar with the lower fill level E. In one example, the bottom wall 324 is generally planar and in an intersecting plane with the upstanding wall 306, and, in this example, the bottom wall 324 may be in an intersecting plane with the base 308 (such as sloped toward the base 308) or may be in a parallel plane with the base 308. The bottom wall 324 and base 308 form a sump 326 proximate the base 308, or over the base 308 when the printing device is standing in the operating configuration and adjacent the bottom wall 324. The sump 326 can contain print substance 322 between the base 308 and the lower fill level E when the printing device 200 is standing in the operating configuration. In one example, the bottom wall 324 can be sloped toward the sump 326 to direct the print substance 322 into the sump 326. In one example, the print substance 322 in the sump 326 above the base 308 cannot be extracted from the print substance reservoir 302, such as via channel 218, and provided to the print head 208 while the printing device 200 is standing in the operating configuration. For instance, a print substance 322 can remain in the sump while a controller 210 indicates the print substance reservoir is empty.

The sump 326 includes a depth between the base 308 and the lower fill level E. The depth is selected such that the effective fringing field from the reference full sensor 318 into the sump 326 is covered with enough print substance 322 that a varying height H of the print substance 322 will not measurably affect the capacitance of the reference full sensor 318. For example, the entire effective fringing field in the reservoir interior 310 generated by the reference full sensor 318 is contained within the sump 326. A sump 326 can be included to reduce the amount of print substance at the lower fill level E that remains in the print substance reservoir 302 to cover the reference full sensor 318.

The sensor system 314 further includes a reference empty sensor 320. The reference empty sensor 320 is disposed on the print substance container 300 such that the generated effective fringing field of the reference empty sensor 320 does extend into the print substance 322 within the reservoir interior 310. In one example, the reference empty sensor 320 is attached to the flange 312 remote from the print substance reservoir 302 or to the print substance reservoir 302 above the upper fill level F such that the generated effective fringing field of the reference empty sensor 320 does not extend into the reservoir interior 310. The reference empty sensor 320 includes an adjacent plate capacitor having a first electrode 352 and a second electrode 354. In the example, the electrodes 352, 354 can provide an effective fringing field through the flange 312 and remote from the print substance 322 such that the height H of the print substance 322 within the reservoir interior 310 does not measurably affect the capacitance of the reference empty sensor 320. In one example, the reference empty sensor 320 can provide the controller 210 with a signal representative of the print substance reservoir 302 devoid of print substance or filled with print substance 322 at the lower fill level E subjected to environmental conditions. Level sensor 316 is operably coupled to reference full sensor 318 and reference empty sensor 320 to detect the level of the print substance in reservoir interior 310, such as via controller 210 implementing example method 100.

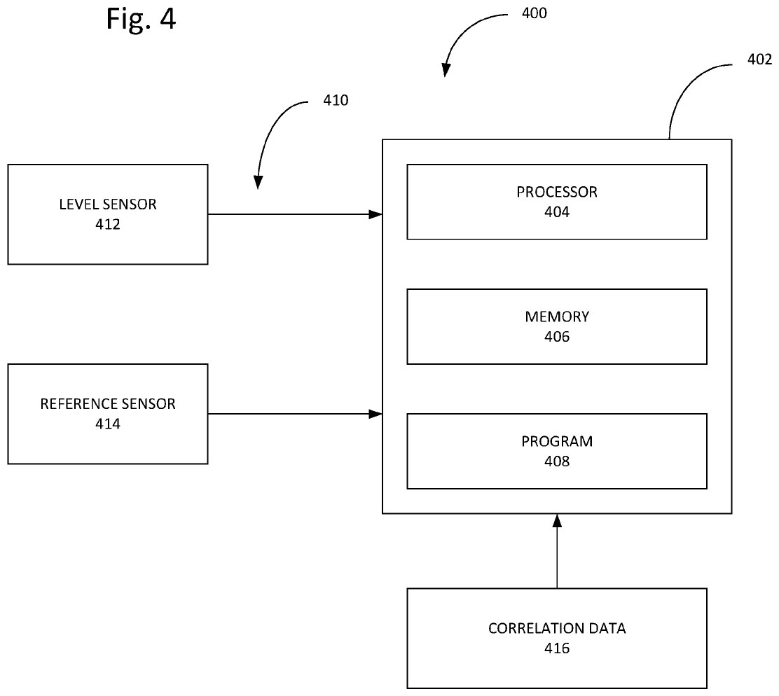

FIG. 4 illustrates an example system 400 including a computing or processing device 402 having a processor 404 and memory 406 and program 408 to implement example method 100. In one example, the computing or processing device 402 can be implemented in the controller 210 of printing device 200. Program 408 can be implemented as a set of processor-executable instructions stored on a non-transitory computer readable medium. Computer readable media, computer storage media, or memory may be implemented to include a volatile computer storage media, nonvolatile computer storage media, or as any suitable method or technology for storage of information such as computer readable instructions, data structures, program modules or other data. A propagating signal by itself does not qualify as storage media or a memory device.

System 400 can be configured to receive signals 410 representative of capacitance measurements from sensor system 214 such as a level sensor 412 and a reference sensor 414. The reference sensor 414 can include one of or both the reference full sensor, such as sensor 318, and the reference empty sensor, such as sensor 320. In one example, a level sensor 412 and a reference sensor 414 are coupled to a capacitance to digital converter, and the signals 410 representative of capacitance measurements from level sensor 412 and reference sensor 414 are provided as digital signals from the capacitance to digital converter. In another example, the capacitance to digital converter is included in system 400 and the signals 410 are analog signals of capacitance from the level sensor 412 and the reference sensor 414. Additionally, the system 400 can receive data used to apply the correlation at 106, such as the slope and y-intercept values, from correlation data from memory device 416. The correlation data from memory device 416 can be stored in memory 406 of the system 400 and used to determine the adjusted reference capacitance at 106. The system 400 can also store additional information in memory 406, such as information on the size and shape of the print substance reservoir and upper and lower fill levels to determine amounts, such as volume, of print substances from the fill level ratio determined at 108.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A method of determining a level of a print substance in a print substance reservoir, comprising:
measuring a reference capacitance of a reference sensor, the reference capacitance representative of one of a full print substance reservoir and an empty print substance reservoir;
measuring a level capacitance of a level sensor;
applying a correlation between the reference sensor and the level sensor to the measured reference capacitance to determine an adjusted reference capacitance; and
determining a fill level ratio based on the measured level capacitance and the adjusted reference capacitance.

2. The method of claim 1 wherein the measuring the reference capacitance includes measuring a reference full capacitance with a reference full sensor, the reference full capacitance representative of the full print substance reservoir and measuring a reference empty capacitance with a reference empty sensor, the reference empty capacitance representative of the empty print substance reservoir.

3. The method of claim 2 further comprising applying a correlation between the reference full sensor and the reference empty senor for a selected print substance to the measured reference full capacitance and the measured reference empty capacitance.

4. The method of claim 1 wherein applying the correlation between the reference sensor and the level sensor includes applying a correlation between a reference full sensor and the level sensor to determine an adjusted reference full capacitance and applying a correlation between a reference empty sensor and the level sensor to determine an adjusted reference empty capacitance.

5. The method of claim 4 wherein determining the fill level ratio includes determining a fill level ratio based on the measured level capacitance, the adjusted reference full capacitance, and the adjusted reference empty capacitance.

6. The method of claim 1 wherein applying the correlation includes calculating the correlation based on a linear equation having a determine slope and a determined y-intercept.

7. The method of claim 1 wherein determining the fill level ratio includes one of determining the fill level ratio as a percentage of the print substance reservoir that includes print substance and determining the fill level ratio as a percentage of the print substance reservoir that is devoid of print substance.

8. The method of claim 1 wherein determining the fill level ratio includes determining a ratio of a height of the print substance to a height between an upper fill level and a lower fill level of the print substance reservoir.

9. The method of claim 1 comprising calculating an amount of the print substance in the print substance reservoir based on the fill level ratio.

10. A printing device, comprising:
a print substance container having a print substance reservoir and a sensor system having a level sensor and a reference sensor, the level sensor operably coupled to the print substance reservoir; and
a controller operably coupled to the sensor system, the controller to:
measure a reference capacitance of a reference sensor, the reference capacitance representative of one of a full print substance reservoir and an empty print substance reservoir;
measure a level capacitance of a level sensor;
apply a correlation between the reference sensor and the level sensor to the measured reference capacitance to determine an adjusted reference capacitance; and
determine a fill level ratio based on the measured level capacitance and the adjusted reference capacitance.

11. The printing device of claim 10 wherein sensor system includes a reference full capacitor and a reference empty capacitor, and the reference capacitance includes a reference full capacitance measured with the reference full capacitance and a reference empty capacitance measured with the reference empty sensor.

12. The printing device of claim 10 wherein the controller includes a capacitance to digital converter operably coupled to the sensor system.

13. A non-transitory computer readable medium to store computer executable instructions to control a processor to:
measure a reference capacitance of a reference sensor, the reference capacitance representative of one of a full print substance reservoir and an empty print substance reservoir;
measure a level capacitance of a level sensor;
apply a correlation between the reference sensor and the level sensor to the measured reference capacitance to determine an adjusted reference capacitance; and
determine a fill level ratio based on the measured level capacitance and the adjusted reference capacitance.

14. The non-transitory computer readable medium of claim 13 wherein the reference capacitance includes a reference full capacitance provided from a reference full sensor and a reference empty capacitance provided from a reference empty sensor.

15. The non-transitory computer readable medium of claim 13 wherein the correlation is applied via a calculation with a linear equation having a slope and y-intercept values stored in a memory.
